(19) United States
(12) Patent Application Publication
(10) Pub. No.: US 2025/0364878 A1
(43) Pub. Date: Nov. 27, 2025

(54) POWER CONTROL ACTUATOR

(71) Applicant: SONY GROUP CORPORATION, TOKYO (JP)

(72) Inventor: KIYOKAZU MIYAZAWA, TOKYO (JP)

(21) Appl. No.: 18/872,284

(22) PCT Filed: Apr. 28, 2023
(86) PCT No.: PCT/JP2023/016800

§ 371 Date: Dec. 6, 2024

(30) Foreign Application Priority Data
Jun. 17, 2022 (JP) 2022-098068

(51) Int. Cl. H02K 11/24; H02K 7/08

(52) U.S. Cl. CPC H02K 11/24; H02K 7/08

(57) ABSTRACT

A power control actuator of the present disclosure includes: an output-side bearing provided on a side on which a torque is to be outputted; a speed reducer including an output shaft; and a torque sensor that detects a torque associated with rotation of the output shaft, in which an outer peripheral surface of the torque sensor and an inner peripheral surface of the output-side bearing constitute a spigot joint structure, an inner peripheral surface of the torque sensor and an outer peripheral surface of the output shaft of the speed reducer constitute a spigot joint structure, and the output-side bearing, the output shaft of the speed reducer, and the torque sensor have a coaxial structure.

### TECHNICAL FIELD

The present disclosure relates to a power control actuator.

### BACKGROUND ART

In recent years, a power control (torque controlled type) actuator is used in various apparatuses. For example, a robot arm (manipulator) is known. In this robot arm, a power control actuator is provided in a joint portion of the robot, and a plurality of arms is coupled through this joint portion. Power control is control in which a target value of force to be applied to an operation target is directly received, and an actuator is driven on the basis of the target value. Typically, the power control actuator includes a torque sensor used to perform the power control (see, for example, Patent Literature 1).

### CITATION LIST

### Patent Literature

PTL 1: Japanese Unexamined Patent Application Publication No. 2017-151072

### SUMMARY OF THE INVENTION

A power control actuator is demanded to increase the accuracy of detection of a torque by a torque sensor in order to achieve accurate power control. In addition, the actuator is demanded to reduce its size for the purpose of reducing the size of the manipulator.

It is desirable to provide a power control actuator that has a reduced size and makes it possible to increase the accuracy of detection of a torque.

A power control actuator according to one embodiment of the present disclosure includes: an output-side bearing provided on a side on which a torque is to be outputted; a speed reducer including an output shaft; and a torque sensor that detects a torque associated with rotation of the output shaft, in which an outer peripheral surface of the torque sensor and an inner peripheral surface of the output-side bearing have a spigot joint structure, an inner peripheral surface of the torque sensor and an outer peripheral surface of the output shaft of the speed reducer have a spigot joint structure, and the output-side bearing, the output shaft of the speed reducer, and the torque sensor have a coaxial structure.

In the power control actuator according to one embodiment of the present disclosure, the torque sensor is fixed to the output-side bearing and the output shaft of the speed reducer with the spigot joint structure, and the output-side bearing, the output shaft of the speed reducer, and the torque sensor have a coaxial structure.

### BRIEF DESCRIPTION OF DRAWING

FIG. 1 is a block diagram schematically illustrating one example of a structure in which a power control actuator according to a comparative example is coupled to a robot.

FIG. 2 is a perspective diagram of an external appearance schematically illustrating one configuration example of a power control actuator according to one embodiment of the present disclosure.

FIG. 3 is a cross-sectional diagram schematically illustrating one configuration example of the power control actuator according to one embodiment.

FIG. 4 is an exploded cross-sectional diagram schematically illustrating one configuration example of the power control actuator according to one embodiment.

FIG. 5 is an elevation diagram schematically illustrating one configuration example of a torque sensor in the power control actuator according to one embodiment.

FIG. 6 is a cross-sectional diagram schematically illustrating one configuration example of the torque sensor in the power control actuator according to one embodiment.

FIG. 7 is a circuit diagram illustrating an equivalent circuit of the torque sensor in the power control actuator according to one embodiment.

FIG. 8 is a diagram used to describe one example of a method of suppressing a fluctuation in sensor values of torque sensors in the power control actuator according to one embodiment.

FIG. 9 is a diagram used to describe one example of a method of suppressing a change in sensor values of torque sensors between before and after the power control actuator according to one embodiment is attached to a robot.

FIG. 10 is a diagram used to describe one example of idealized joint control using the power control actuator according to one embodiment.

### MODES FOR CARRYING OUT THE INVENTION

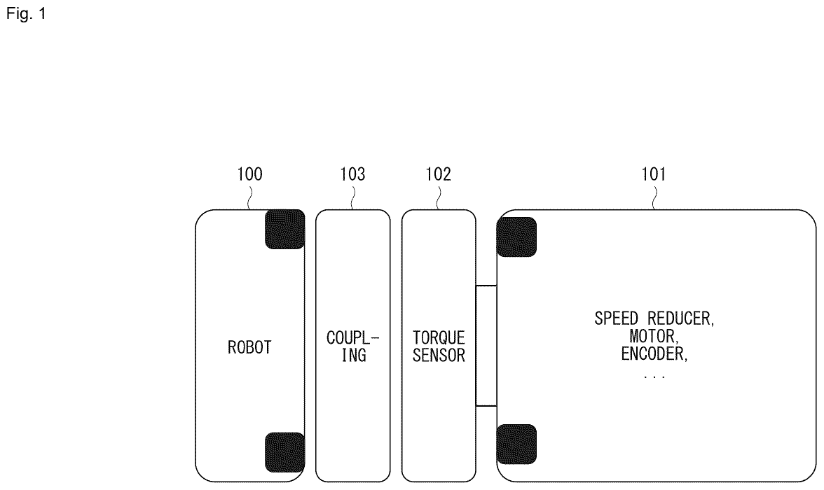

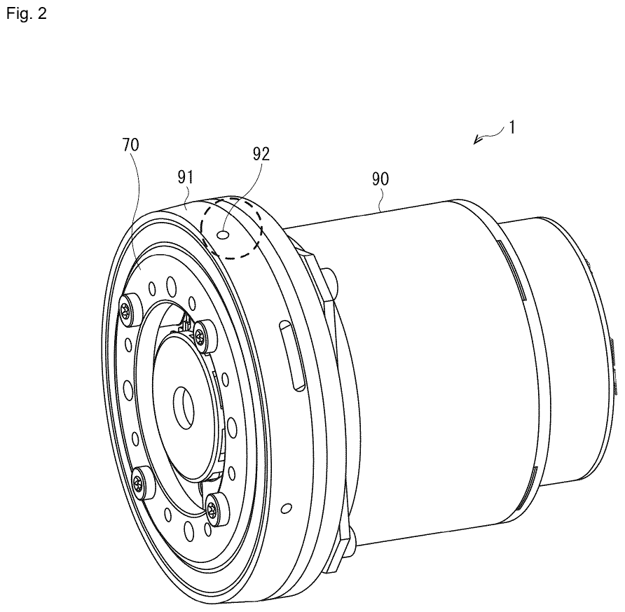

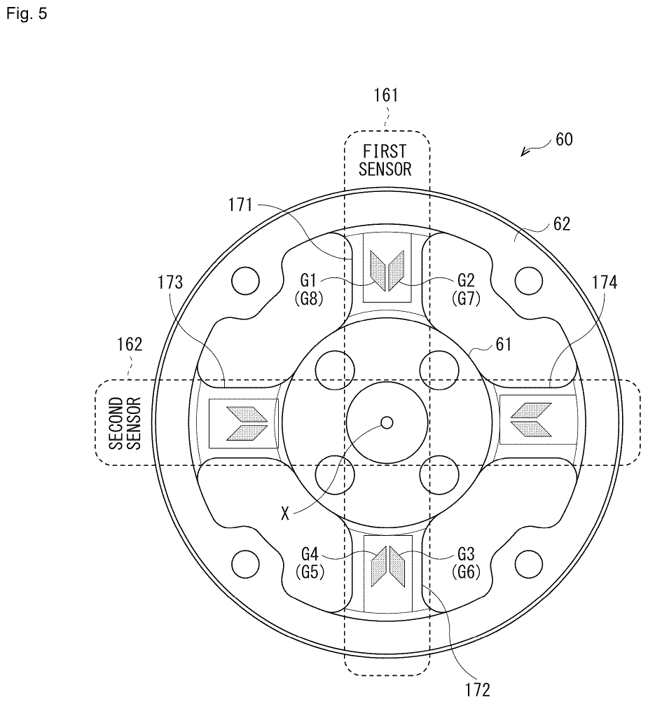

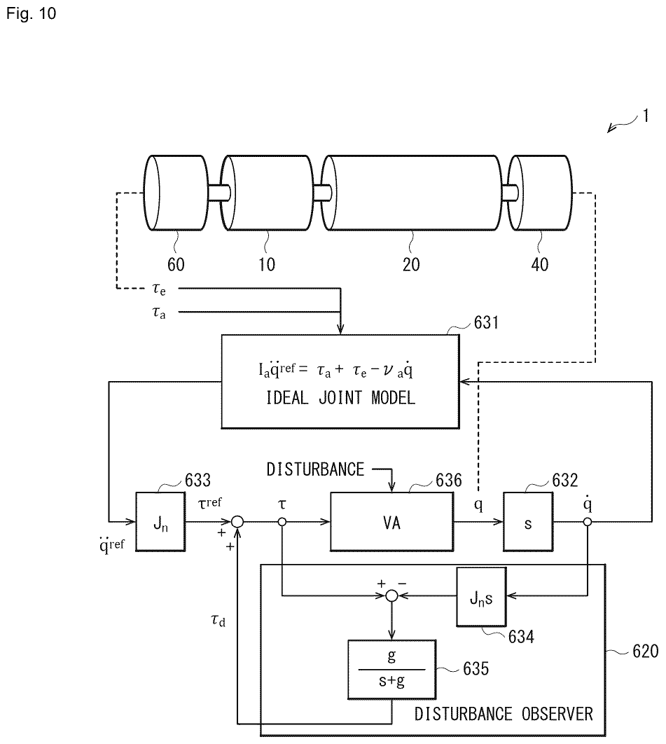

Below, embodiment according to the present disclosure will be described in detail with reference to the drawings. Note that description will be made in the following order.
0. Comparative Example (FIG. 1)
1. One Embodiment
   1.1 One Configuration Example of Power Control Actuator (FIGS. 2 to 4)
   1.2 Specific Example of Torque Sensor (FIGS. 5 to 9)
   1.3 Specific Example of Idealized Joint Control (FIG. 10)
   1.4 Effects
2. Other embodiment

### 0. Comparative Example

### Structure of Actuator According to Comparative Example and Its Problem

In order to solve social issues such as shortage of workers, there is an increasing demand for a manipulator that autonomously operates in the same environment as humans. The manipulator uses a power control actuator including a torque sensor, for example. In a collaborative robot including such a manipulator, it is demanded to accurately detect external force and appropriately control a torque in order to ensure safety, thereby achieving safety operation. The manipulator is desirable to have a reduced size from the viewpoint of collision safety and controllability. In order to reduce the size of the manipulator, the actuator is desired to have the reduced size. In addition, in order to accurately control a torque in a more safety manner, it is desired that the torque acting on the manipulator should be accurately detected, and be transferred without any backlash. For this reason, in order to achieve accurate power control, the power control actuator is desired to increase the accuracy of detection of a torque by a torque sensor. In addition, it is desired to provide such a human collaborative manipulator at very low cost.

FIG. 1 schematically illustrates one example of a structure in which a power control actuator according to a comparative example is coupled to a robot 100.

A speed reducer, a motor, an encoder, and the like are disposed in an actuator main body 101. A torque sensor 102 is mounted at an output section of the actuator in order to detect external force. Power of the motor of the actuator is transmitted to the robot 100 through the torque sensor 102. The torque sensor 102 includes a structural body called a strain generation body that is easily deformed. The strain generation body includes an element that makes it possible to detect the deformation. Upon receiving a torque from the inside of the actuator and receiving a torque from the outside, the strain generation body is deformed, and at the same time, the torque is transmitted to the torque sensor 102. By detecting this deformation, the torque sensor 102 makes it possible to detect a torque acting on the actuator.

The torque sensor 102 is mounted at an intermediate section interposed between a bearing at the actuator side and a bearing at the robot side. In addition, the torque sensor 102 is coupled to the robot 100 through a coupling 103 such as an “Oldham slider.” The torque sensor 102 is structured such that, with the coupling 103 and the bearing structure, the external force other than a torque with the rotating axis being the center is not transmitted to the torque sensor 102 as much as possible. How to firmly fix a portion adjacent to the strain generation body of the torque sensor 102 and cause an actual torque generated at the actuator to act on the strain generation body as much as possible is an important factor to achieve the high accuracy. If misalignment occurs when the actuator is assembled to the frame of the robot 100, the strain generation body of the torque sensor 102 always remains deformed. This has an influence on the accuracy of detection of a torque. Thus, an intermediate transmission structure that absorbs the misalignment of the center of the coupling 103 and the like is employed. However, in a case where a coupling structure is employed, looseness (backlash) exists between the coupling 103 and the robot 100. This leads to a deterioration in controllability of the robot 100. Misalignment between the actuator and the robot 100 may be able to be reduced by increasing the manufacturing accuracy and adjusting the assembly between components. This leads to an increase in the cost due to the number of adjustment processes and components being manufactured with high accuracy.

For this reason, it is demanded to develop an output structure for a power control actuator that has resistance to external force with no coupling being provided, and makes it possible to highly accurately detect a torque at low cost.

### 1. One Embodiment

### 1.1 One Configuration Example of Power Control Actuator

### Overall Configuration

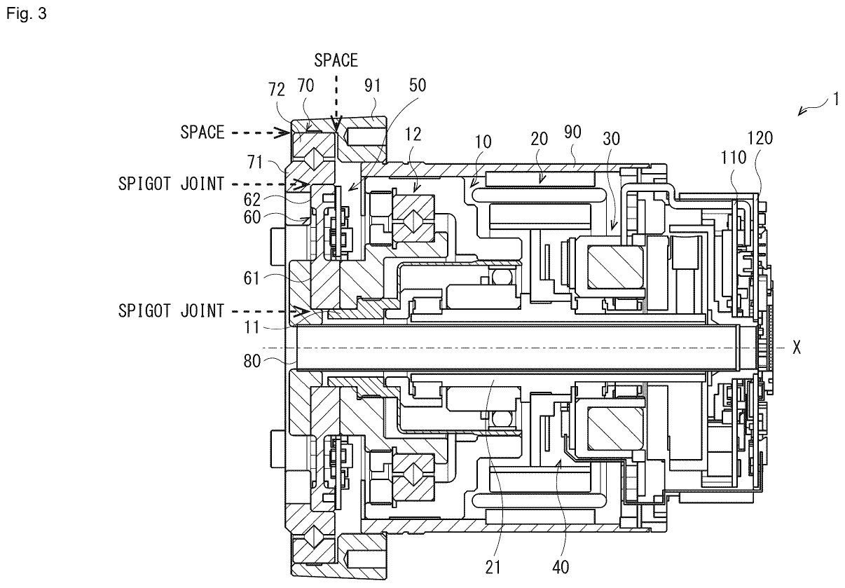

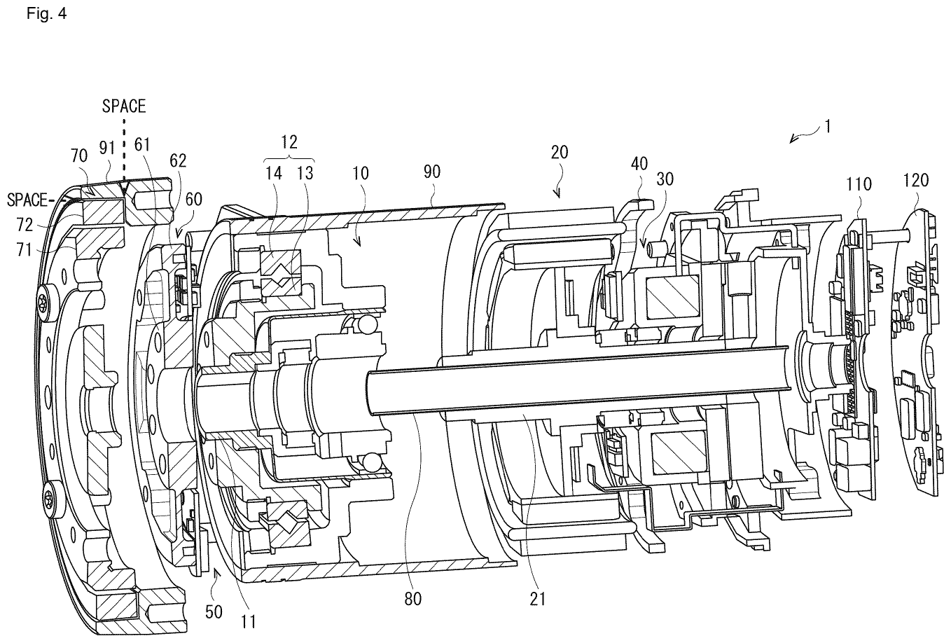

FIGS. 2 to 4 each schematically illustrate one configuration example of a power control actuator 1 according to one embodiment of the present disclosure. FIG. 2 is a perspective diagram of the external appearance of the power control actuator 1. FIG. 3 is a cross-sectional view of the power control actuator 1. FIG. 4 is an exploded cross-sectional view of the power control actuator 1.

The power control actuator 1 according to one embodiment is applicable to a joint portion of a manipulator of a robot or the like, for example. The power control actuator 1 includes a speed reducer 10, a motor 20, a brake 30, an input-side encoder 40, an output-side encoder 50, a torque sensor 60, an output-side cross roller bearing 70, a driver substrate 110, and a VA controlling microcomputer substrate 120. In addition, the power control actuator 1 includes a hollow tube 80, a housing 90, and an output frame 91. The driver substrate 110 and the VA controlling microcomputer substrate 120 are controllers used to achieve a virtualized actuator (VA: Virtualized Actuator) with idealized joint control that will be described later.

Here, the right side in FIG. 3 is referred to as an input side of the power control actuator 1, and the left side in FIG. 3 is referred to as an output side of the power control actuator 1, for example. In addition, the X axis in FIG. 3 is referred to as a center axis of the power control actuator 1, for example. The center axis of the hollow tube 80 is the same axis as the center axis X of the power control actuator 1. The VA controlling microcomputer substrate 120, the driver substrate 110, the brake 30, the input-side encoder 40, the motor 20, the speed reducer 10, the output-side encoder 50, the torque sensor 60, and the output-side cross roller bearing 70 are sequentially arranged along the center axis X in this order from the input side toward the output side. Note that the order of arrangement of these components is not limited to this.

### Housing 90

The housing 90 has, for example, a tubular shape, and accommodates the brake 30, the input-side encoder 40, the motor 20, and the speed reducer 10, for example.

### Brake 30

The brake 30 is disposed around the hollow tube 80, and is able to be disposed so as to be coaxial with the hollow tube 80. The brake 30 reduces the speed of rotation of the motor 20. It may be possible that the brake 30 is a power-off brake, for example. The brake 30 is disposed at a side opposite to the speed reducer 10 with respect to the motor 20. That is, the brake 30 is disposed at a position before speed reduction by the speed reducer 10. This makes it possible to reduce the brake torque necessary to stop rotation of the motor 20 by a reducing ratio of the speed reducer 10. This makes it possible to reduce the size of the mechanism of the brake 30.

### Input-Side Encoder 40

The input-side encoder 40 is disposed around the hollow tube 80, and is able to be disposed so as to be coaxial with the hollow tube 80. The input-side encoder 40 acquires information regarding rotation such as a rotational angle of the motor 20. The input-side encoder 40 is, for example, a reflection-type optical absolute encoder, and detects an absolute rotational angle or the like of the motor 20, for example. It may be possible that the input-side encoder 40 is fixed to the brake 30, for example.

### Motor 20

The motor 20 is disposed around the hollow tube 80, and is able to be disposed so as to be coaxial with the hollow tube 80. Upon being energized, the motor 20 rotates to generate a rotational torque. It may be possible that the motor 20 is, for example, a coreless motor. The motor 20 includes a motor shaft 21. The motor shaft 21 is a rotating shaft of the motor 20. It may be possible that the motor shaft 21 is a hollow shape. It may be possible that the hollow tube 80 is disposed within the motor shaft 21.

### Speed Reducer 10

The speed reducer 10 is disposed around the hollow tube 80, and is able to be disposed so as to be coaxial with the hollow tube 80. It may be possible that the speed reducer 10 is configured with a harmonic drive (registered trademark) serving as a strain wave gearing having a flexspline, for example. In this case, it may be possible that the flexspline is an output shaft 11 of the speed reducer 10. The speed reducer 10 reduces rotational speed generated by the motor 20 at a predetermined reducing ratio, thereby generating rotational drive force (torque). At the speed reducer 10, the output shaft 11 rotates at a reduced speed. A torque associated with the rotation of the output shaft 11 of the speed reducer 10 is transmitted to the torque sensor 60 through the output shaft 11. The speed reducer 10 includes an actuator-side cross roller bearing 12. The actuator-side cross roller bearing 12 includes an inner ring 13 and an outer ring 14. The output shaft 11 is rotatably supported through the actuator-side cross roller bearing 12.

### Output-Side Encoder 50

The output-side encoder 50 acquires information regarding rotation such as a rotational angle of the output shaft 11 of which speed is reduced by the speed reducer 10, and is outputted. The output-side encoder 50 is, for example, a reflection-type optical absolute encoder, and detects an absolute rotational angle or the like of the output shaft 11, for example. It may be possible that the output-side encoder 50 is fixed to the torque sensor 60, for example.

### Torque Sensor 60

The torque sensor 60 is fixed to the output shaft 11 of the speed reducer 10, and detects a torque (generated torque of the power control actuator 1) corresponding to rotation of the output shaft 11. The torque sensor 60 includes a first rotating body 61 and a second rotating body 62 that are provided concentrically so as to have diameters differing from each other. The second rotating body 62 is provided at the outer side than the first rotating body 61. In other words, the first rotating body 61 is provided at the inner side than the second rotating body 62. The first rotating body 61 and the second rotating body 62 are coupled to each other through the strain generation body. The strain generation body may be a plurality of bar sections (first to fourth bar sections 171 to 174) as illustrated in FIG. 5 that will be described later, for example. The strain generation body includes a strain gauge. The strain gauge may be a plurality of strain gauges G1 to G8 illustrated in FIG. 5 that will be described later, for example.

The torque sensor 60 detects the rotational torque corresponding to a result of detection of deformation occurring in the strain generation body. The second rotating body 62 at the outer side is coupled to the first rotating body 61 through the strain generation body, and the rotational torque inputted into the first rotating body 61 is transmitted to the second rotating body 62 through the strain generation body. The output-side cross roller bearing 70 is linked to the second rotating body 62, whereby the output-side cross roller bearing 70 rotates with the rotation of the second rotating body 62. At this time, while deforming, the strain generation body transmits the rotational torque inputted into the first rotating body 61 to the second rotating body 62.

### Output-Side Cross Roller Bearing 70, Output Frame 91

The output-side cross roller bearing 70 is an output-side bearing provided at the side at which the torque made by the power control actuator 1 is outputted. The output-side cross roller bearing 70 includes an inner ring 71 and an outer ring 72. A space is provided between an outer peripheral surface, in an axial direction (thrust direction) of the output-side cross roller bearing 70, of the outer ring 72 and the inner peripheral surface of the output frame 91. In addition, a space is provided between an outer peripheral surface, in the radial direction (radial direction) of the output-side cross roller bearing 70, of the outer ring 72 and the inner peripheral surface of the output frame 91.

In the power control actuator 1, the outer peripheral surface (the outer peripheral surface of the second rotating body 62) of the torque sensor 60 and the inner peripheral surface (the inner peripheral surface of the inner ring 71) of the output-side cross roller bearing 70 are configured as a spigot joint structure. In addition, the inner peripheral surface (the inner peripheral surface of the first rotating body 61) of the torque sensor 60 and the outer peripheral surface of the output shaft 11 of the speed reducer 10 constitute a spigot joint structure. Thus, the output-side cross roller bearing 70, the output shaft 11 of the speed reducer 10, and the torque sensor 60 have a coaxial structure.

The output frame 91 is attached to the output-side cross roller bearing 70 such that a space lies with respect to the outer peripheral surface of the output-side cross roller bearing 70. The output frame 91 includes a fastening hole 92 through which a fastening member such as a screw penetrates as illustrated in FIG. 2. The output frame 91 and the output-side cross roller bearing 70 are fastened with the fastening member through the fastening hole 92 and the space. This configuration enables the torque sensor 60 to be provided at the output-side cross roller bearing 70 without applying any load on the strain generation body. Note that it may be possible to employ a configuration in which an adhesive is used to cause the inner peripheral surface of the output frame 91 and the outer peripheral surface of the output-side cross roller bearing 70 to bond together so as to fill the space.

It is better that the size of the space provided between the output-side cross roller bearing 70 and the output frame 91 is at least larger than a cumulative tolerance of the output frame 91 and the output-side cross roller bearing 70. By using the spigot joint structure to cause the output-side cross roller bearing 70, the output shaft 11 of the speed reducer 10, and the torque sensor 60 to have a coaxial structure, it is possible to cause the cumulative tolerance resulting from assembly of individual components in the output section of the power control actuator 1 to happen mainly at a portion of the outer ring 72 of the output-side cross roller bearing 70. In one embodiment, it is possible to perform fastening with a fastening member such as a screw from the outer circumferential direction or perform bonding to fix while absorbing the misalignment between the center of the power control actuator 1 and the center of the output frame 91 by using the space provided between the output-side cross roller bearing 70 and the output frame 91. By preventing load from acting on the strain generation body of the torque sensor 60 while sufficiently receiving external force at the output-side cross roller bearing 70, it is possible to achieve the power control actuator 1 that makes it possible to highly accurately detect a torque with reduced backlash.

In addition, in one embodiment, the output-side cross roller bearing 70 serving as a bearing and the torque sensor 60 are integrated using the spigot joint structure. This makes it possible to reduce the size and also enhance the structural rigidity. As the torque sensor 60 is disposed at the inner diameter section of the output-side cross roller bearing 70, it is possible to reduce the thickness and also enhance the rigidity of the output side of the strain generation body of the torque sensor 60. This makes it possible to reduce the size of the structural body of the output side of the power control actuator 1, and also possible to improve the sensor sensitivity of the torque sensor 60 to increase the accuracy of detection of a torque.

For example, in a case of arms of a vertical articulated structure, even if the backlash of a robot joint is small, an end-point position error increases from the base toward the distal end. With decrease in the backlash, it is possible to increase the accuracy of detection of a torque, and also possible to improve the repetitive error of the end-point position and the absolute accuracy. In one embodiment, it is only necessary to increase the size of the space provided between the output-side cross roller bearing 70 and the output frame 91 so as to be larger than the cumulative tolerance resulting from assembly of individual components in the output section. This makes it possible to obtain the effect described above even if the machining tolerance is large. As the demand for the machining tolerance reduces, cost reduction is expected, as compared with a method using a coupling structure obtained through highly accurate machining.

### 1.2 Specific Example of Toque Sensor 60

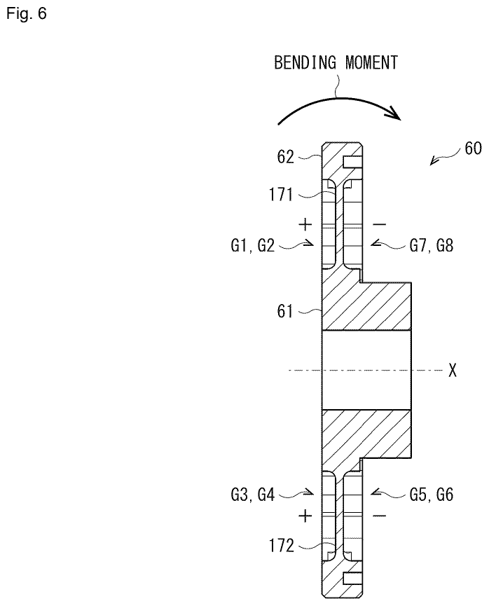

FIG. 5 is an elevation diagram schematically illustrating one configuration example of the torque sensor 60 in the power control actuator 1 according to one embodiment. FIG. 6 is a cross-sectional diagram schematically illustrating one configuration example of the torque sensor 60 in the power control actuator 1 according to one embodiment. Note that FIG. 5 illustrates a configuration example as viewed from the output side, for example. In addition, FIG. 6 illustrates a configuration example in cross section including the first bar section 171 and the second bar section 172 of the torque sensor 60. In FIG. 6, the left side is an output side (output-side cross roller bearing 70 side), and the right side is an input side (speed reducer 10 side).

The torque sensor 60 includes the first rotating body 61 and the second rotating body 62 provided concentrically so as to have diameters differing from each other, as described above. Furthermore, the torque sensor 60 has the strain generation body provided so as to couple the first rotating body 61 and the second rotating body 62 as described above. Here, description will be made of a configuration example in which the strain generation body includes the first to fourth bar sections 171 to 174 extending radially with the center axis X being the center.

The first to fourth bar sections 171 to 174 are provided such that bar sections adjacent to each other form an angle of 90 degrees in the circumferential direction, for example. The first bar section 171 and the second bar section 172 couple the first rotating body 61 and the second rotating body 62 to each other such that these bar sections are opposed to each other at an angle of 180 degrees with the first rotating body 61 being interposed between them. The first bar section 171 includes a front surface provided with a plurality of strain gauges G1 and G2 and also includes a rear surface provided with a plurality of strain gauges G7 and G8, for example. The second bar section 172 includes a front surface provided with a plurality of strain gauges G3 and G4 and also includes a rear surface provided with a plurality of strain gauges G5 and G6, for example. The first sensor 161 includes the plurality of strain gauges G1, G2, G7, and G8 included in the first bar section 171 and also includes the plurality of strain gauges G3, G4, G5, and G6 included in the second bar section 172.

In directions each differing from the first bar section 171 and the second bar section 172 at 90 degrees in the circumferential direction, the third bar section 173 and the fourth bar section 174 couple the first rotating body 61 and the second rotating body 62 to each other such that these bar sections are opposed to each other at an angle of 180 degrees with the first rotating body 61 being interposed between them. Although illustration is not given, the third bar section 173 includes a front surface provided with a plurality of strain gauges G1 and G2 and also includes a rear surface provided with a plurality of strain gauges G7 and G8, as with the first bar section 171, for example. In addition, although illustration is not given, the fourth bar section 174 includes a front surface provided with a plurality of strain gauges G3 and G4 and also includes a rear surface provided with a plurality of strain gauges G5 and G6, as with the second bar section 172, for example. The second sensor 162 includes the plurality of strain gauges G1, G2, G7, and G8 included in the third bar section 173 and also includes the plurality of strain gauges G3, G4, G5, and G6 included in the fourth bar section 174.

The torque sensor 60 outputs, as a sensor value of the torque sensor 60, the sum of a first sensor value by the first sensor 161 and a second sensor value by the second sensor 162.

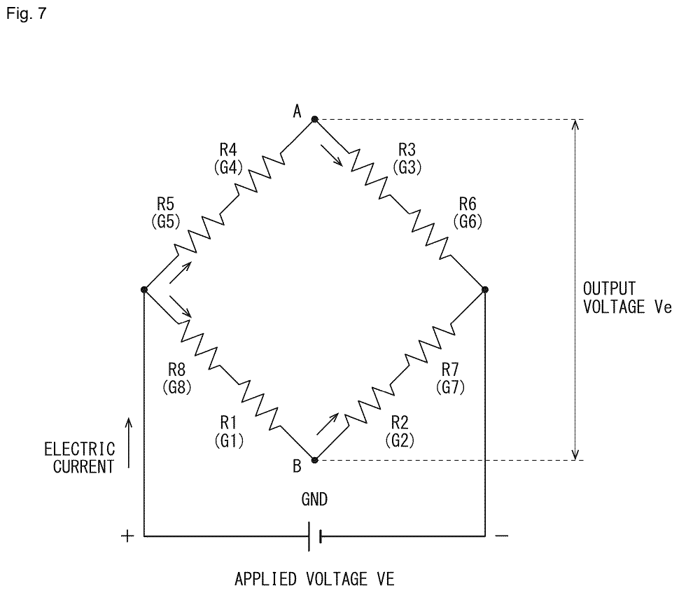

FIG. 7 illustrates an equivalent circuit of the torque sensor 60 in the power control actuator 1 according to one embodiment. Note that, here, the constituent components (the first bar section 171 and the second bar section 172) of the first sensor 161 will be described as an example. However, this similarly applies to the constituent components (the third bar section 173 and the fourth bar section 174) of the second sensor 162.

In the torque sensor 60, a bridge (Wheatstone bridge) with an eight-active four-gauge method is configured with the plurality of strain gauges G1, G2, G7, and G8 provided in the first bar section 171 and the plurality of strain gauges G3, G4, G5, and G6 provided in the second bar section 172. In FIG. 7, equivalent resistors including the plurality of strain gauges G1, G2, G7, and G8 provided in the first bar section 171 are indicated as R1, R2, R7, and R8. In addition, equivalent resistors including the plurality of strain gauges G3, G4, G5, and G6 provided in the second bar section 172 are indicated as R3, R4, R5, and R6. In the torque sensor 60, a circuit in which the resistors R1, R2, R7, and R8 are arranged in series and a circuit in which the resistors R3, R4, R5, and R6 are arranged in series are coupled in parallel, thereby configuring a bridge with an eight-active four-gauge method.

When deformation occurs in the first bar section 171 and the second bar section 172 serving as the strain generation body, a resistor value of each of the resistors changes in accordance with the deformation in the equivalent circuit in FIG. 7. When a voltage VE is applied across both ends of the circuit in which the circuit including the resistors R1, R2, R7, and R8 and the circuit including the resistors R3, R4, R5, and R6 are coupled in parallel, a difference in the electric potential between a middle point B of the circuit including the resistors R1, R2, R7, and R8 and a middle point A of the circuit including the resistors R3, R4, R5, and R6 is outputted as an output voltage Ve serving as a sensor value of the torque sensor 60.

Here, it is assumed that clockwise bending moment occurs in the torque sensor 60 as illustrated in FIG. 6, for example. In this case, the plurality of strain gauges G1 and G2, and G3 and G4 provided at individual front surfaces of the first bar section 171 and the second bar section 172 stretch. On the other hand, the plurality of strain gauges G7 and G8, and G5 and G6 provided at individual rear surfaces of the first bar section 171 and second bar section 172 compress. This causes resistor values to change so as to cancel the resistors R1 and R2, and R3 and R4 corresponding to the front surface of each of the first bar section 171 and the second bar section 172 and the R7 and R8, and R5 and R6 corresponding to the rear surface against each other. With this configuration, it is possible to suppress an influence of deformation due to bending moment around the axis perpendicular to the center axis X, which makes it possible to increase the accuracy of detection of a rotational torque with the center axis X being the rotating axis, this rotational torque being the target of detection by the torque sensor 60.

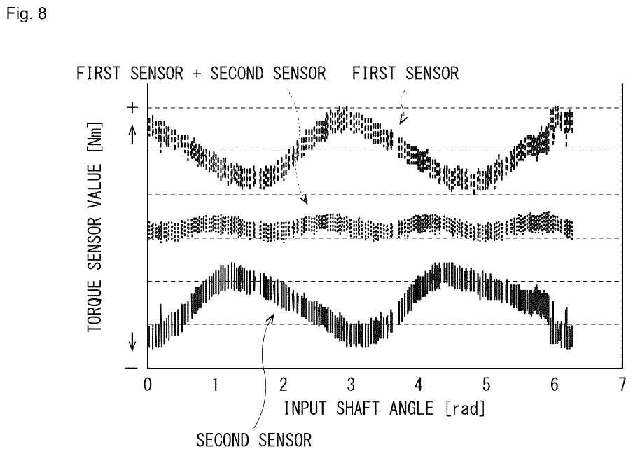

FIG. 8 is a diagram used to describe one example of a method of suppressing a fluctuation in sensor values of the torque sensor 60 in the power control actuator 1 according to one embodiment.

FIG. 8 illustrates torque sensor values (output voltages) detected by the first sensor 161 and torque sensor values (output voltages) detected by the second sensor 162. In addition, FIG. 8 illustrates the sum of the torque sensor value detected by the first sensor 161 and the torque sensor value detected by the second sensor 162.

The torque sensor value detected by the first sensor 161 and the torque sensor value detected by the second sensor 162 periodically fluctuate. Meanwhile, in one embodiment, the first sensor 161 and the second sensor 162 are configured in directions differing at 90 degrees from each other in the circumferential direction. With this configuration, a torque noise detected by the first sensor 161 and a torque noise detected by the second sensor 162 appear with inverted phases to each other. Thus, by adding the torque sensor value detected by the first sensor 161 and the torque sensor value detected by the second sensor 162 together, it is possible to suppress this periodic fluctuations, which makes it possible to increase the accuracy of detection by the torque sensor 60.

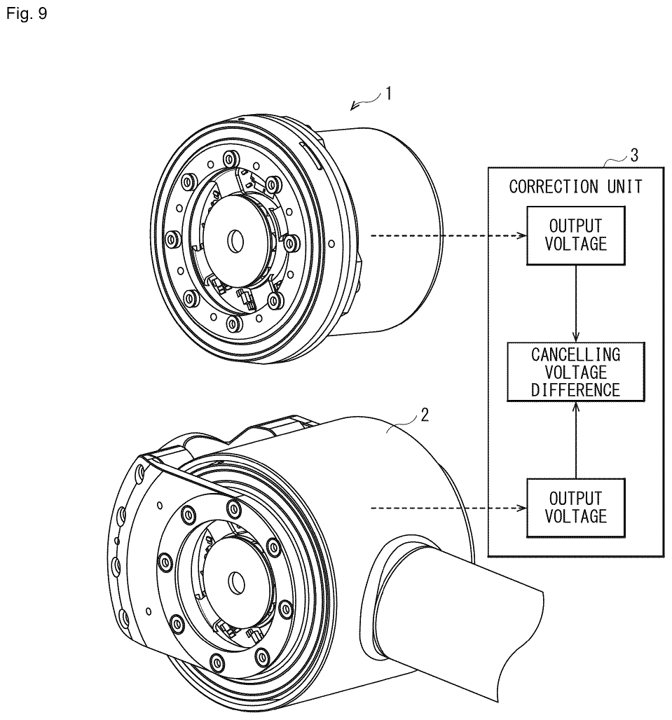

FIG. 9 is a diagram used to describe one example of a method of suppressing a change in sensor values of the torque sensor 60 between before and after the power control actuator 1 according to one embodiment is attached to a robot 2.

For example, by using a female screw provided in an inner ring 71 of the output-side cross roller bearing 70, the power control actuator 1 is attached to a target of attachment such as the robot 2. In this case, sensor values of the torque sensor 60 may change between before and after attachment. Thus, it may be possible to provide a correction unit 3 that corrects the sensor value of the torque sensor 60 after attachment to the target of attachment. It may be possible that the correction unit 3 includes a processor. The correction unit 3 cancels a difference in voltages between before and after attachment on the basis of a difference between the sensor value (output voltage) of the torque sensor 60 before attachment to the target of attachment such as the robot 2 and the sensor value of the torque sensor 60 after attachment to the target of attachment, thereby correcting the sensor value of the torque sensor 60 after attachment to the target of attachment. With this configuration, the influence of attachment to the robot 2 or the like through screw fastening on the torque sensor 60 is cancelled, for example.

### 1.3 Specific Example of Idealized Joint Control

Here, description will be made of an example in which the power control actuator 1 is applied to a joint portion of a manipulator of a robot, for example. Motion of the joint portion is modeled by an equation of motion of a second-order delay system in the following Expression (1).

### Equation 1

Here, Iₐ represents a moment of inertia (inertia) (target inertia) at a joint portion; τₐ represents a generated torque (target torque) at the joint portion; τₑ represents an external torque acting on the joint portion from the outside; Vₐ represents a viscous resistance coefficient (target viscous resistance) at the joint portion; and q represents a rotational angle (joint angle). It can also be said that the Expression (1) described above is a theoretical mode representing a motion of the power control actuator 1 at the joint portion.

Through computation using generalized inverse dynamics, by using motion objectives and constraints, it is possible to calculate the generated torque τₐ serving as an actual force to be acted on the joint portion in order to achieve the motion objectives. Thus, ideally, by applying the calculated generated torque τₐ to the Equation (1) described above, a response according with the theoretical mode indicated by the Equation (1) is achieved. That is, the desired motion objectives are supposed to be achieved.

In reality, however, due to influences of various disturbances, there is a possibility that an error (modelization error) occurs between the motion of a joint portion and the theoretical mode indicated by Equation (1) described above. It is possible to divide the modelization error into an error due to a mass property such as the weight of, the center of gravity of, or the inertia tensor of a multilink structural body, and an error due to friction or inertia within a joint portion. Of these errors, it is possible to relatively easily reduce the former modelization error, which results from a mass property, by increasing the accuracy of CAD (computer aided design) data or applying an identification method at the time of establishing the theoretical mode.

On the other hand, the latter modelization error due to friction or inertia or the like within the joint portion results from, for example, friction or the like of the speed reducer 10 of the joint portion that is a phenomenon difficult to be modeled, and a modelization error that cannot be ignored may still remain at the time of establishing the theoretical mode. In addition, there is a possibility that an error exists between values of the inertia la or the viscous resistance coefficient νₐ in Equation (1) described above and these values of the actual joint portion. These errors that are difficult to be modeled may cause disturbance in driving control of the joint portion. Thus, due to an influence of such disturbance, the motion of a joint portion may not actually respond so as to accord with the theoretical mode shown by the Equation (1) described above, in some cases. For this reason, even if the generated torque Ta that is force of a joint calculated using the generalized inverse dynamics is applied, the motion objectives that are the target of control may not be achieved, in some cases. One embodiment considers correcting the response of a joint portion such that an active control system is added to the joint portion to perform the ideal response according with the theoretical mode shown by the Equation (1) described above. Specifically, one embodiment not only performs, to a joint portion, torque control of a friction compensation type using the torque sensor 60, but also makes it possible to perform the ideal response according with a theoretical value to the demanded generated torque τₐ and the external torque τₑ while taking into consideration the inertia Iₐ and the viscous resistance coefficient νₐ.

In one embodiment, controlling drive of a joint portion such that the joint portion performs the ideal response according with the Equation (1) in this manner is referred to as idealized joint control. Here, in the following description, an actuator of which drive is controlled through the idealized joint control is also referred to as a virtualized actuator (VA: Virtualized Actuator) because ideal response is performed. The power control actuator 1 performs the response according with the theoretical mode indicated by the Equation (1) described above, which makes it possible to cancel mechanical impedances within the power control actuator 1 and also possible to achieve an agile and smooth operation and an operation in which inertia is large. In addition, it is possible to reduce the size of and the weight of the power control actuator 1 and also possible to achieve the agile operation.

FIG. 10 is an explanatory view of one example of the idealized joint control using the power control actuator 1 according to one embodiment. Note that FIG. 10 schematically illustrates blocks representing conceptual computing units that perform various types of computation concerning the idealized joint control. In addition, in FIG. 10, the block 636 indicates the virtual actuator (VA) described above.

Here, the power control actuator 1 performs the response according with the theoretical mode indicated by the Equation (1) described above. This means that the target value (second order derivative of a target value q^{ref} of a rotational angular) of the rotational angular velocity at the left-hand side is achieved when the right-hand side of the Equation (1) is given. In addition, as indicated by the Equation (1), the theoretical mode includes the term of external torque τₑ acting on the power control actuator 1. In one embodiment, in order to perform the idealized joint control, the external torque τₑ is measured by the torque sensor 60. Furthermore, a disturbance observer 620 is employed in order to calculate a disturbance estimation value τ_{d} that is an estimation value of a torque resulting from a disturbance on the basis of a rotational angle (joint angle) q of the power control actuator 1 measured by the input-side encoder 40.

The block 631 represents a computing unit that performs computation according with the ideal joint model of a joint portion indicated by the Equation (1) described above. By using input of the generated torque Ta, the external torque τₑ, and the rotational angular velocity (the first order derivative of the rotational angle q), the block 631 makes it possible to output the target value of the rotational angular velocity indicated at the left-hand side of the Equation (1) described above.

In one embodiment, the generated torque ta calculated with the generalized inverse dynamics and the external torque τₑ measured by the torque sensor 60 are inputted into the block 631. In addition, the rotational angle q measured by the input-side encoder 40 is inputted into the block 632 representing a computing unit that performs differentiation computation to calculate the rotational angular velocity (the first order derivative of the rotational angle q). In addition to the generated torque τₐ and the external torque τₑ described above, the rotational angular velocity calculated by the block 632 is inputted into the block 631, and the target value of the rotational angular velocity is calculated by the block 631. The thus calculated target value of the rotational angular velocity is inputted into the block 633.

The block 633 represents a computing unit that calculates a torque generated at the power control actuator 1 on the basis of the target value of the rotational angular velocity of the power control actuator 1. Specifically, in one embodiment, the block 633 multiplies the target value of the rotational angular velocity by a nominal inertial Jₙ in the power control actuator 1 to obtain a torque target value τ^{ref}. In the ideal response, the power control actuator 1 is caused to generate the torque target value τ^{ref}, whereby desired motion objects are supposed to be achieved. However, as described above, there is a possibility that an influence such as disturbance occurs in the actual response. Thus, in one embodiment, a disturbance estimation value τ_{d} is calculated in the disturbance observer 620 to correct the torque target value τ^{ref} using the disturbance estimation value τ_{d}.

The configuration of the disturbance observer 620 will be described. As illustrated in FIG. 10, the disturbance observer 620 calculates the disturbance estimation value τ_{d} on the basis of the torque command value τ and the rotational angular velocity calculated on the basis of the rotational angle q measured by the input-side encoder 40. Here, the torque command value τ is a value of torque that the power control actuator 1 is caused to generate in the end after the influence of disturbance is corrected. For example, in a case where the disturbance estimation value τ_{d} is not calculate, the torque command value τ is the torque target value τ^{ref}.

The disturbance observer 620 includes a block 634 and a low-pass filter 635. The block 634 represents a computing unit that calculates a torque generated at the power control actuator 1 on the basis of the rotational angular velocity of the power control actuator 1. Specifically, in one embodiment, the rotational angular velocity calculated by the block 632 on the basis of the rotational angle q measured by the input-side encoder 40 is inputted into the block 634. The block 634 performs computation expressed by a transfer function Jₙs, that is, applies differentiation to the rotational angular velocity to obtain a rotational angular acceleration, and further multiplies the calculated rotational angular acceleration by the nominal inertia Jₙ. This makes it possible to calculate an estimation value (torque estimation value) of the torque actually acting on the power control actuator 1.

Within the disturbance observer 620, a difference between the torque estimation value and the torque command value τ is obtained to estimate the disturbance estimation value τ_{d} that is a value of a torque due to disturbance. Specifically, the disturbance estimation value τ_{d} may be a difference between the torque command value t at the previous cycle of controlling and the torque estimation value at the current cycle of controlling. The torque estimation value calculated in the block 634 is based on the actually measured value. In addition, the torque command value τ calculated in the block 633 is based on the ideal theoretical mode of a joint portion indicated in the block 631. Thus, by acquiring a difference between these values, it is possible to estimate the influence of disturbance that is not considered in the theoretical mode described above.

Furthermore, the low-pass filter 635 is provided in the disturbance observer 620 to prevent the system from diverging. The low-pass filter 635 performs computation represented by a transfer function g/(s+g), and outputs only a low frequency component relative to the inputted value, thereby stabilizing the system. In one embodiment, a difference value between the torque estimation value calculated in block 634 and the torque command value τ^{ref} is inputted into the low-pass filter 635 to calculate the low frequency component of this value as the disturbance estimation value τ_{d}.

One embodiment performs feed-forward control in which the disturbance estimation value τ_{d} calculated by the disturbance observer 620 is added to the torque target value τ^{ref} to calculate the torque command value τ that is a value of torque that is finally generated at the power control actuator 1. Then, the power control actuator 1 is driven on the basis of the torque command value τ. Specifically, the torque command value t is converted into a corresponding electric current value (current command value), and this current command value is applied to the motor 20 to drive the power control actuator 1.

As described above, by employing the configuration described with reference to FIG. 10, even in a case where a component of disturbance such as friction exists, it is possible to cause the response of the power control actuator 1 to follow the target value in the drive control of the joint portion according to one embodiment. In addition, as for the drive control of the joint portion, it is possible to perform the ideal response according with the inertia Iₐ and the viscous resistance coefficient νₐ that the theoretical mode assumes.

### 1.4 Effects

As described above, with the power control actuator 1 according to one embodiment, the torque sensor 60 is fixed to the output-side bearing (output-side cross roller bearing 70) and the output shaft 11 of the speed reducer 10 with the spigot joint structure. In addition, the output-side bearing, the output shaft 11 of the speed reducer 10, and the torque sensor 60 have a coaxial structure. This makes it possible to reduce the size and also increase the accuracy of detection of a torque.

Note that the effects described in the present description are given merely as examples, and are not limited to these effects. Other effects may be possible. This similarly applies to effects of other embodiments described below.

### 2. Other Embodiments

The technique of the present disclosure is not limited to that described in the one embodiment described above, and various modified implementations are possible.

For example, the present technology may take the following configurations. With the present technology having the following configurations, the torque sensor is fixed to the output-side bearing and the output shaft of the speed reducer with the spigot joint structure, and the output-side bearing, the output shaft of the speed reducer, and the torque sensor have a coaxial structure. This makes it possible to reduce the size and increase the accuracy of detection of a torque.

(1) A power control actuator including:
an output-side bearing provided on a side on which a torque is to be outputted;
a speed reducer including an output shaft; and
a torque sensor that detects a torque associated with rotation of the output shaft, in which
an outer peripheral surface of the torque sensor and an inner peripheral surface of the output-side bearing constitute a spigot joint structure,
an inner peripheral surface of the torque sensor and an outer peripheral surface of the output shaft of the speed reducer constitute a spigot joint structure, and
the output-side bearing, the output shaft of the speed reducer, and the torque sensor have a coaxial structure.

(2) The power control actuator according to (1) described above further including
an output frame attached to the output-side bearing and has a space relative to an outer peripheral surface of the output-side bearing.

(3) The power control actuator according to (2) described above, in which
the space has a size larger than at least a cumulative tolerance of the output frame and the output-side bearing.

(4) The power control actuator according to (2) or (3) described above, in which
the output frame has a fastening hole through which a fastening member penetrates, and
the output frame and the output-side bearing are fastened by the fastening member through the fastening hole and the space.

(5) The power control actuator according to any one of (2) to (4) described above, in which
the output-side bearing includes a cross roller bearing including an inner ring and an outer ring, and
the space is provided between an outer peripheral surface, in an axial direction of the output-side cross roller bearing, of the outer ring and an inner peripheral surface of the output frame and between an outer peripheral surface, in a radial direction of the output-side cross roller bearing, of the outer ring and an inner peripheral surface of the output frame.

(6) The power control actuator according to any one of (1) to (5) described above, in which the torque sensor includes:
a first rotating body;
a second rotating body provided on an outer side of the first rotating body;
a first bar section including a front surface and a rear surface each including a plurality of strain gauges, the first bar section coupling the first rotating body and the second rotating body to each other; and
a second bar section including a front surface and a rear surface each including a plurality of strain gauges, the second bar section coupling the first rotating body and the second rotating body to each other, the second bar section being opposed to the first bar section with the first rotating body being interposed between the second bar section and the first bar section, and
the plurality of strain gauges provided in the first bar section and the plurality of strain gauges provided in the second bar section constitute a Wheatstone bridge.

(7) The power control actuator according to any one of (1) to (6) described above, in which the torque sensor includes:
a first rotating body;
a second rotating body provided on an outer side of the first rotating body;
first and second bar sections each including a plurality of strain gauges, the first and the second bar sections coupling the first rotating body and the second rotating body to each other to allow the first and the second bar sections to be opposed to each other with the first rotating body being interposed between the first and the second bar sections; and
third and fourth bar sections each including a plurality of strain gauges, the third and fourth bar sections coupling the first rotating body and the second rotating body to each other to allow the third and fourth bar sections to be opposed to each other with the first rotating body being interposed between the third and fourth bar sections in a direction differing from the first and the second bar sections,
the plurality of strain gauges provided in the first bar section and the plurality of strain gauges provided in the second bar section constitute a first sensor,
the plurality of strain gauges provided in the third bar section and the plurality of strain gauges provided in the fourth bar section constitute a second sensor, and
a sum of a first sensor value by the first sensor and a second sensor value by the second sensor is outputted as a sensor value of the torque sensor.

(8) The power control actuator according to any one of (1) to (7) described above, further including:
a correction unit that corrects a sensor value of the torque sensor after attachment to a target of attachment, on a basis of a difference between a sensor value of the torque sensor before the attachment to the target of attachment and a sensor value of the torque sensor after the attachment to the target of attachment.

(9) The power control actuator according to any one of (1) to (8) described above, in which
the speed reducer includes a strain wave gearing including a flexspline, and
the flexspline constitutes the output shaft of the speed reducer.

This application claims priority based on Japanese Patent Application No. 2022-098068 filed on Jun. 17, 2022 with Japan Patent Office, the entire contents of which are incorporated in this application by reference.

It should be understood that those skilled in the art would reach various modifications, combinations, sub-combinations and alterations depending on design requirements and other factors insofar as they fall within the scope of the appended claims or the equivalents thereof.

1. A power control actuator comprising:
an output-side bearing provided on a side on which a torque is to be outputted;
a speed reducer including an output shaft; and
a torque sensor that detects a torque associated with rotation of the output shaft, wherein
an outer peripheral surface of the torque sensor and an inner peripheral surface of the output-side bearing constitute a spigot joint structure,
an inner peripheral surface of the torque sensor and an outer peripheral surface of the output shaft of the speed reducer constitute a spigot joint structure, and
the output-side bearing, the output shaft of the speed reducer, and the torque sensor have a coaxial structure.

2. The power control actuator according to claim 1, further comprising:
an output frame attached to the output-side bearing and has a space relative to an outer peripheral surface of the output-side bearing.

3. The power control actuator according to claim 2, wherein
the space has a size larger than at least a cumulative tolerance of the output frame and the output-side bearing.

4. The power control actuator according to claim 2, wherein
the output frame has a fastening hole through which a fastening member penetrates, and
the output frame and the output-side bearing are fastened by the fastening member through the fastening hole and the space.

5. The power control actuator according to claim 2, wherein
the output-side bearing includes a cross roller bearing including an inner ring and an outer ring, and
the space is provided between an outer peripheral surface, in an axial direction of the output-side cross roller bearing, of the outer ring and an inner peripheral surface of the output frame and between an outer peripheral surface, in a radial direction of the output-side cross roller bearing, of the outer ring and an inner peripheral surface of the output frame.

6. The power control actuator according to claim 1, wherein
the torque sensor includes:
a first rotating body;
a second rotating body provided on an outer side of the first rotating body;
a first bar section including a front surface and a rear surface each including a plurality of strain gauges, the first bar section coupling the first rotating body and the second rotating body to each other; and
a second bar section including a front surface and a rear surface each including a plurality of strain gauges, the second bar section coupling the first rotating body and the second rotating body to each other, the second bar section being opposed to the first bar section with the first rotating body being interposed between the second bar section and the first bar section, and
the plurality of strain gauges provided in the first bar section and the plurality of strain gauges provided in the second bar section constitute a Wheatstone bridge.

7. The power control actuator according to claim 1, wherein
the torque sensor includes:
a first rotating body;
a second rotating body provided on an outer side of the first rotating body;
first and second bar sections each including a plurality of strain gauges, the first and the second bar sections coupling the first rotating body and the second rotating body to each other to allow the first and the second bar sections to be opposed to each other with the first rotating body being interposed between the first and the second bar sections; and
third and fourth bar sections each including a plurality of strain gauges, the third and fourth bar sections coupling the first rotating body and the second rotating body to each other to allow the third and fourth bar sections to be opposed to each other with the first rotating body being interposed between the third and fourth bar sections in a direction differing from the first and the second bar sections,
the plurality of strain gauges provided in the first bar section and the plurality of strain gauges provided in the second bar section constitute a first sensor,
the plurality of strain gauges provided in the third bar section and the plurality of strain gauges provided in the fourth bar section constitute a second sensor, and
a sum of a first sensor value by the first sensor and a second sensor value by the second sensor is outputted as a sensor value of the torque sensor.

8. The power control actuator according to claim 1, further comprising:
a correction unit that corrects a sensor value of the torque sensor after attachment to a target of attachment, on a basis of a difference between a sensor value of the torque sensor before the attachment to the target of attachment and a sensor value of the torque sensor after the attachment to the target of attachment.

9. The power control actuator according to claim 1, wherein
the speed reducer includes a strain wave gearing including a flexspline, and
the flexspline constitutes the output shaft of the speed reducer.
